(19) United States
(12) Patent Application Publication
(10) Pub. No.: US 2015/0188797 A1
(43) Pub. Date: Jul. 2, 2015

(54) ADAPTIVE ADMISSION CONTROL FOR ON DIE INTERCONNECT

(71) Applicants: Guy Satat, Zichron Yakov (IL); Evgeny Bolotin, Haifa (IL); Julius Mandelblat, Haifa (IL); Jayesh Gaur, Bangalore (IN); Supratik Majumder, Bangalore (IN); Ravi K. Venkatesan, Bangalore (IN)

(72) Inventors: Guy Satat, Zichron Yakov (IL); Evgeny Bolotin, Haifa (IL); Julius Mandelblat, Haifa (IL); Jayesh Gaur, Bangalore (IN); Supratik Majumder, Bangalore (IN); Ravi K. Venkatesan, Bangalore (IN)

(21) Appl. No.: 14/142,748

(22) Filed: Dec. 27, 2013

(51) Int. Cl. H04L 12/26; G06F 15/173

(52) U.S. Cl. CPC H04L 43/0888; G06F 15/17337; H04L 43/16; G06F 15/8069

(57) ABSTRACT

Methods and apparatus relating to adaptive admission control for on die interconnect are described. In one embodiment, admission control logic determines whether to cause a change in an admission rate of requests from one or more sources of data based at least in part on comparison of a threshold value and resource utilization information. The resource utilization information is received from a plurality of resources that are shared amongst the one or more sources of data. The threshold value is determined based at least in part on a number of the plurality of resources that are determined to be in a congested condition. Other embodiments are also disclosed.

### FIELD

The present disclosure generally relates to the field of electronics. More particularly, an embodiment of the invention relates to adaptive admission control for on die interconnect.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an embodiment of a computing systems, which can be utilized to implement various embodiments discussed herein.

FIG. 2 illustrates a block diagram of an embodiment of a computing system, which can be utilized to implement one or more embodiments discussed herein.

FIG. 3 illustrates a sample interconnect or network that couples different groups or types of system modules, according to an embodiment.

FIG. 4 illustrates a sample network or interconnect that provides stress signaling towards central admission control for decision on the level of adaptive admission control, according to an embodiment.

FIG. 5 illustrates a sample interconnect or network with admission control policy signaling from admission control component towards Network Interfaces (NIs), according to an embodiment.

FIG. 6 illustrates a flow diagram for admission control, according to an embodiment.

FIG. 7 illustrates a block diagram of a sample ring interconnect, according to an embodiment.

FIG. 8 illustrates a block diagram of a sample ring interconnect with stress detection and signaling for two different types of processor cores, according to an embodiment.

FIG. 9 illustrates a block diagram of a sample ring interconnect with central admission control decision capability, according to an embodiment.

FIG. 10 illustrates a flow diagram for admission control policy signaling and admission control policy enforcement, according to an embodiment.

FIG. 11 illustrates a block diagram of an NI capable of implementing admission control enforcement, according to an embodiment.

FIG. 12 illustrates a block diagram of an embodiment of a computing system, which can be utilized to implement one or more embodiments discussed herein.

FIG. 13 illustrates a block diagram of an embodiment of a computing system, which can be utilized to implement one or more embodiments discussed herein.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments. Various aspects of embodiments of the invention may be performed using various means, such as integrated semiconductor circuits (“hardware”), computer-readable instructions organized into one or more programs (“software”) or some combination of hardware and software. For the purposes of this disclosure reference to “logic” shall mean either hardware, software, or some combination thereof.

Utilization of critical shared resource(s) in on-die interconnection network architectures (such as bus, ring, mesh, or other general topology network) can be crucial to overall system performance. For example, high utilization can lead to overall degraded characteristics of system throughput and latency, especially when the interconnected units have different traffic demands.

To this end, some embodiments provide dynamic and/or adaptive admission control mechanisms for on-die interconnect architectures. Such interconnect admission control techniques may be applied in interconnected system modules, e.g., based on dynamic monitoring of the status of (e.g., critical) shared resource(s) utilization and/or the differences between network traffic applied by the interconnected units. Also, some embodiments may be used to solve or reduce various types of system bottlenecks as will be further discussed herein. Furthermore, in some embodiments, the admission control mechanisms can be contained within the network itself (e.g., and not in the interconnected system modules, which are coupled to the network)

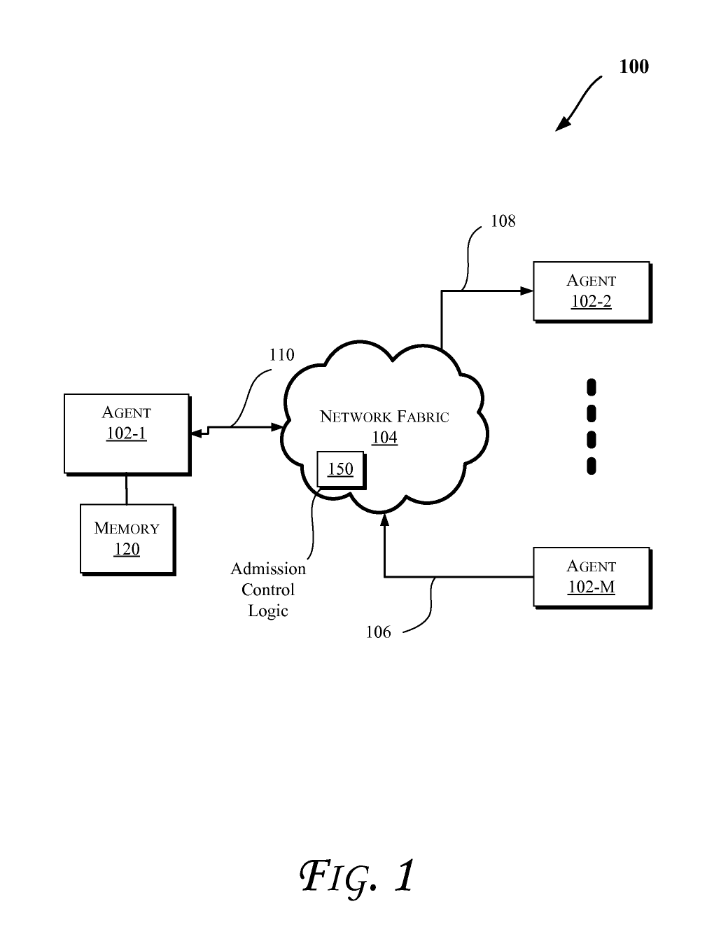

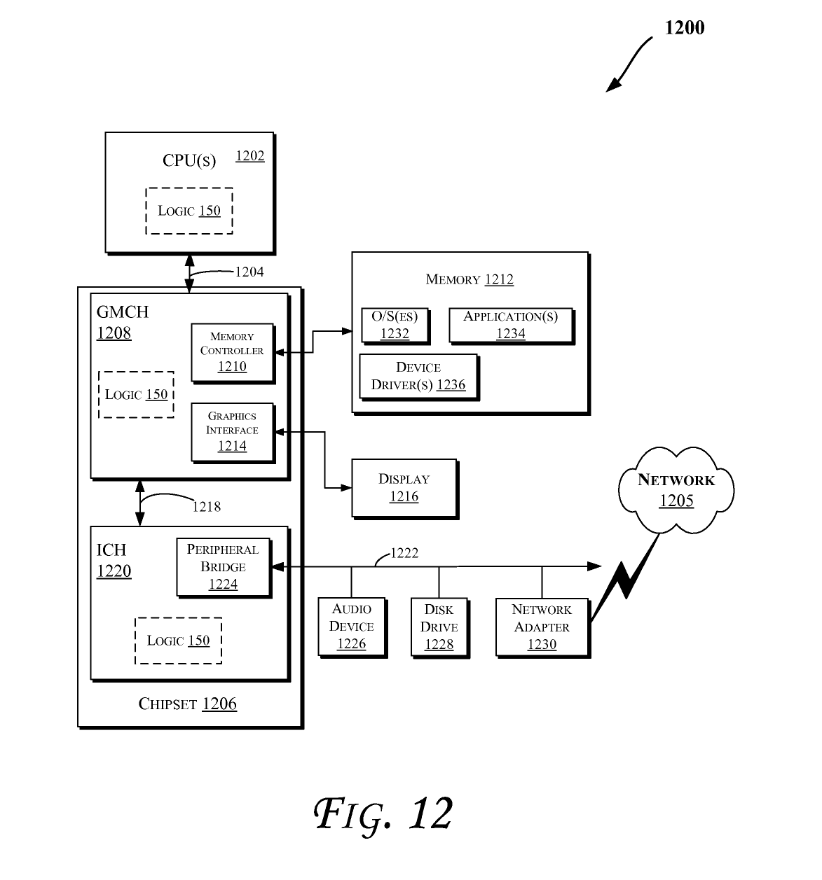

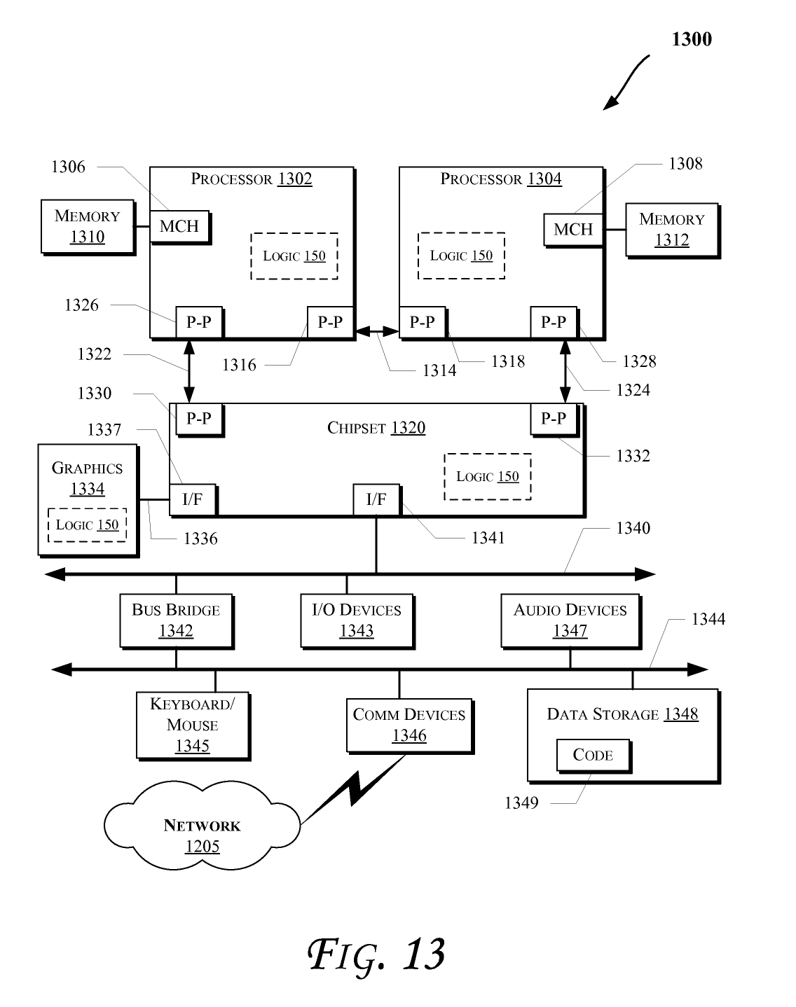

Various computing systems may be used to implement embodiments, discussed herein, such as the systems discussed with reference to FIGS. 1-2 and 12-13. More particularly, FIG. 1 illustrates a block diagram of a computing system 100, according to an embodiment of the invention. The system 100 may include one or more agents 102-1 through 102-M (collectively referred to herein as “agents 102” or more generally “agent 102”). In an embodiment, one or more of the agents 102 may be any of components of a computing system, such as the computing systems discussed with reference to FIGS. 12-13.

As illustrated in FIG. 1, the agents 102 may communicate via a network fabric 104. In one embodiment, the network fabric 104 may include a computer network that allows various agents (such as computing devices) to communicate data. In an embodiment, the network fabric 104 may include one or more interconnects (or interconnection networks) that communicate via a serial (e.g., point-to-point) link and/or a shared communication network (which may be configured as a ring in an embodiment). For example, some embodiments may facilitate component debug or validation on links that allow communication with Fully Buffered Dual in-line memory modules (FBD), e.g., where the FBD link is a serial link for coupling memory modules to a host controller device (such as a processor or memory hub). Debug information may be transmitted from the FBD channel host such that the debug information may be observed along the channel by channel traffic trace capture tools (such as one or more logic analyzers).

In one embodiment, the system 100 may support a layered protocol scheme, which may include a physical layer, a link layer, a routing layer, a transport layer, and/or a protocol layer. The fabric 104 may further facilitate transmission of data (e.g., in form of packets) from one protocol (e.g., caching processor or caching aware memory controller) to another protocol for a point-to-point or shared network. Also, in some embodiments, the network fabric 104 may provide communication that adheres to one or more cache coherent protocols.

Furthermore, as shown by the direction of arrows in FIG. 1, the agents 102 may transmit and/or receive data via the network fabric 104. Hence, some agents may utilize a unidirectional link while others may utilize a bidirectional link for communication. For instance, one or more agents (such as agent 102-M) may transmit data (e.g., via a unidirectional link 106), other agent(s) (such as agent 102-2) may receive data (e.g., via a unidirectional link 108), while some agent(s) (such as agent 102-1) may both transmit and receive data (e.g., via a bidirectional link 110).

Additionally, at least one of the agents 102 may be a home agent and one or more of the agents 102 may be requesting or caching agents. Generally, requesting/caching agents send request(s) to a home node/agent for access to a memory address with which a corresponding “home agent” is associated. Further, in an embodiment, one or more of the agents 102 (only one shown for agent 102-1) may have access to a memory (which may be dedicated to the agent or shared with other agents) such as memory 120. In some embodiments, each (or at least one) of the agents 102 may be coupled to the memory 120 that is either on the same die as the agent or otherwise accessible by the agent. Also, as shown in FIG. 1, network fabric 104 may include one or more admission control logic 150 to dynamically and/or adaptively provide admission control mechanisms for on-die interconnect architectures. For example, logic 150 may be provided in interconnected system modules, e.g., based on dynamic monitoring of the status of (e.g., critical) shared resource(s) utilization and/or the differences between network traffic applied by the interconnected units. Also, in some embodiments, logic 150 may be used to solve or reduce various types of system bottlenecks as will be further discussed herein. Furthermore, in some embodiments, logic 150 can be contained within the network itself (such as the network fabric 104), e.g., and not in the interconnected system modules which are coupled to the network.

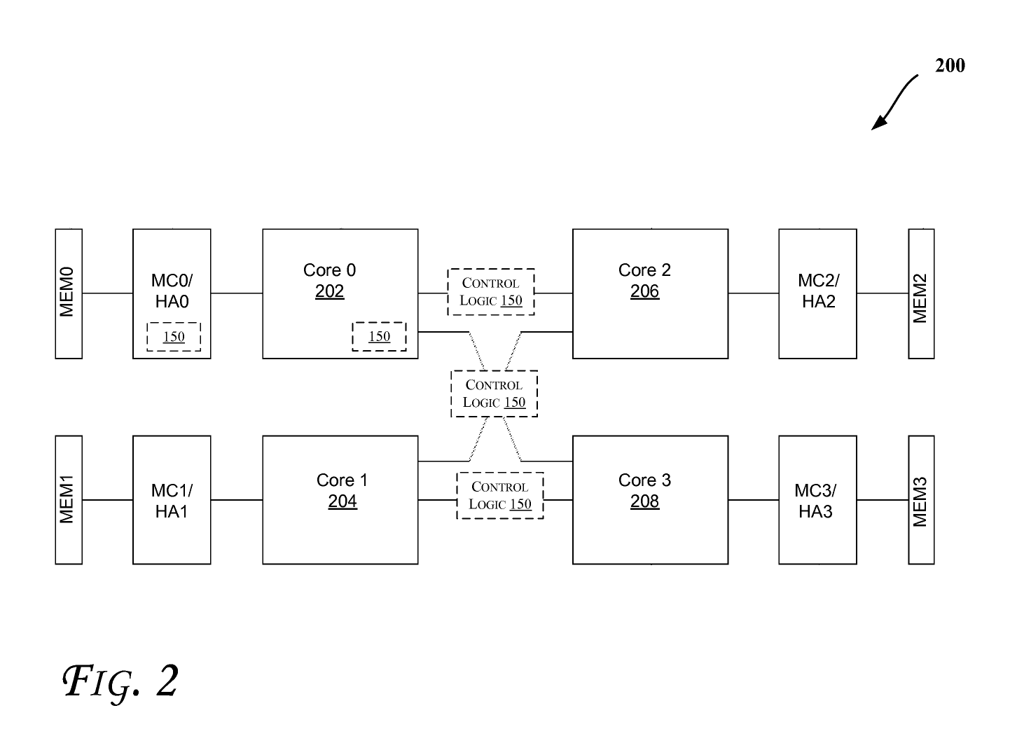

FIG. 2 is a block diagram of a computing system 200 in accordance with an embodiment. System 200 includes a plurality of sockets 202-208 (four shown but some embodiments can have more or less socket). Each socket includes a processor. Also, various agents in the system 200 can communicate via logic 150. Even though logic 150 is only shown coupled to items 202-208 or provided in items 202 or MC0/HA0, logic 150 may couple to or be provided in other agent(s) in system 200. Further, more or less logic blocks can be present in a system depending on the implementation. Additionally, each socket is coupled to the other sockets via a point-to-point (PtP) link, or a differential interconnect, such as a Quick Path Interconnect (QPI), MIPI (Mobile Industry Processor Interface), etc. As discussed with respect the network fabric 104 of FIG. 1, each socket is coupled to a local portion of system memory, e.g., formed by a plurality of Dual Inline Memory Modules (DIMMs) that include dynamic random access memory (DRAM).

In another embodiment, the network fabric may be utilized for any System on Chip (SoC or SOC) application, utilize custom or standard interfaces, such as, ARM compliant interfaces for AMBA (Advanced Microcontroller Bus Architecture), OCP (Open Core Protocol), MIPI (Mobile Industry Processor Interface), PCI (Peripheral Component Interconnect) or PCIe (Peripheral Component Interconnect Express).

Some embodiments use a technique that enables use of heterogeneous resources, such as AXI/OCP technologies, in a PC (Personal Computer) based system such as a PCI-based system without making any changes to the IP resources themselves. Embodiments provide two very thin hardware blocks, referred to herein as a Yunit and a shim, that can be used to plug AXI/OCP IP into an auto-generated interconnect fabric to create PCI-compatible systems. In one embodiment a first (e.g., a north) interface of the Yunit connects to an adapter block that interfaces to a PCI-compatible bus such as a direct media interface (DMI) bus, a PCI bus, or a Peripheral Component Interconnect Express (PCIe) bus. A second (e.g., south) interface connects directly to a non-PC interconnect, such as an AXI/OCP interconnect. In various implementations, this bus may be an OCP bus.

In some embodiments, the Yunit implements PCI enumeration by translating PCI configuration cycles into transactions that the target IP can understand. This unit also performs address translation from re-locatable PCI addresses into fixed AXI/OCP addresses and vice versa. The Yunit may further implement an ordering mechanism to satisfy a producer-consumer model (e.g., a PCI producer-consumer model). In turn, individual IPs are connected to the interconnect via dedicated PCI shims. Each shim may implement the entire PCI header for the corresponding IP. The Yunit routes all accesses to the PCI header and the device memory space to the shim. The shim consumes all header read/write transactions and passes on other transactions to the IP. In some embodiments, the shim also implements all power management related features for the IP.

Thus, rather than being a monolithic compatibility block, embodiments that implement a Yunit take a distributed approach. Functionality that is common across all IPs, e.g., address translation and ordering, is implemented in the Yunit, while IP-specific functionality such as power management, error handling, and so forth, is implemented in the shims that are tailored to that IP.

In this way, a new IP can be added with minimal changes to the Yunit. For example, in one implementation the changes may occur by adding a new entry in an address redirection table. While the shims are IP-specific, in some implementations a large amount of the functionality (e.g., more than 90%) is common across all IPs. This enables a rapid reconfiguration of an existing shim for a new IP. Some embodiments thus also enable use of auto-generated interconnect fabrics without modification. In a point-to-point bus architecture, designing interconnect fabrics can be a challenging task. The Yunit approach described above leverages an industry ecosystem into a PCI system with minimal effort and without requiring any modifications to industry-standard tools.

As shown in FIG. 2, each socket is coupled to a Memory Controller (MC)/Home Agent (HA) (such as MC0/HA0 through MC3/HA3). The memory controllers are coupled to a corresponding local memory (labeled as MEM0 through MEM3), which can be a portion of system memory (such as memory 1212 of FIG. 12). In some embodiments, the memory controller (MC)/Home Agent (HA) (such as MC0/HA0 through MC3/HA3) can be the same or similar to agent 102-1 of FIG. 1 and the memory, labeled as MEM0 through MEM3, can be the same or similar to memory devices discussed with reference to any of the figures herein. Also, in one embodiment, MEM0 through MEM3 can be configured to mirror data, e.g., as master and slave. Also, one or more components of system 200 can be included on the same integrated circuit die in some embodiments.

Furthermore, one implementation (such as shown in FIG. 2) is for a socket glueless configuration with mirroring. For example, data assigned to a memory controller (such as MC0/HA0) is mirrored to another memory controller (such as MC3/HA3) over the PtP links.

Some embodiments discussed herein may be used for various implementations including, for example: (a) central control of (e.g., critical) resource(s) utilization by dynamically throttling the sources of traffic in the system; (b) differentiating and applying different levels of admission control to different sources (or groups of sources) adaptively, e.g., based on their impact on the critical resource utilization and/or overall system throughput; and/or (c) modularity, where the implementation is contained within the network (such as fabric 104 of FIG. 1, network 1205 of FIGS. 12-13, etc.), without impact on interconnected system modules. Hence, some embodiments allow for the network critical resource(s) to have a healthy level of utilization by making sure that aggressive, high-traffic units that degrade system performance are throttled, and other traffic units can receive their fair share of network resources. In other words, some embodiments guarantee programmable level of QoS (Quality of Service) for different types of agents in a system.

Further, some embodiments provide dynamic system congestion alleviations that can be centrally controlled, e.g., and not just based on a peer-to-peer decision-based algorithm. Additionally, at least one embodiment allows for a modular approach, e.g., capable of dealing with various network micro-architectures, control multiple system bottlenecks, and differentiate between network modules and not just tailored to specific agent-network configuration.

Some embodiments provide dynamic and adaptive admission control mechanism for on-die interconnect architectures that is contained within the interconnect architecture. In various embodiments, one or more of the following components (A) to (E) (e.g., which may be implemented by logic 150) are utilized.

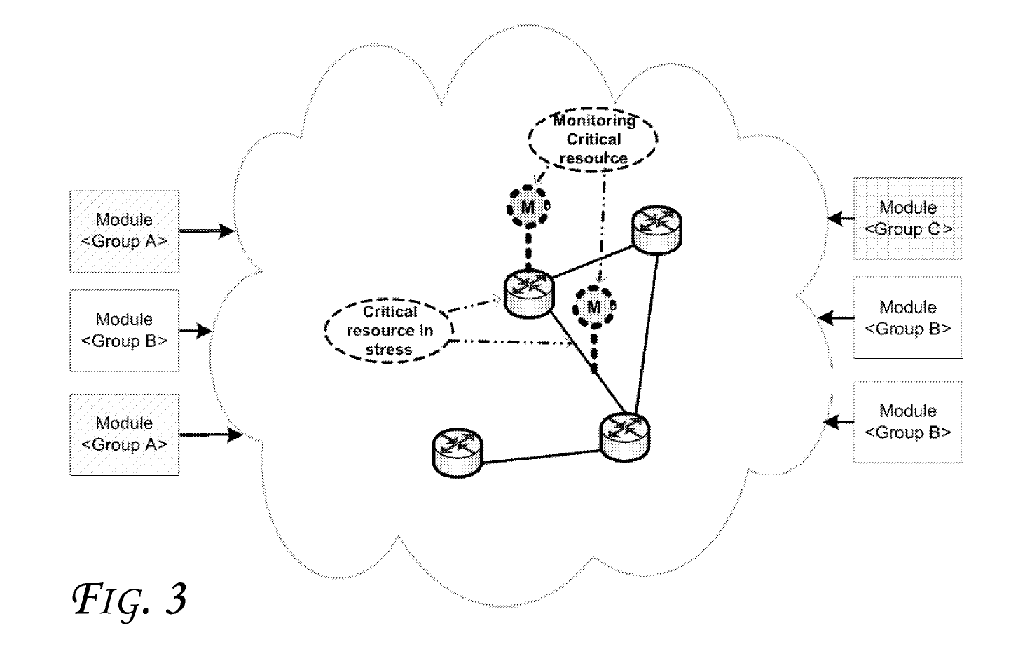

(A) Dynamically monitoring critical resource(s) utilization (also referred to as stress detection, see, e.g., FIG. 3 which illustrates a sample interconnect or network that couples different groups/types of system modules (labeled as type A or B), according to an embodiment), where dynamic monitoring detects congestion (also referred to as stress) in the network resource(s) (illustrated as cylindrical elements in FIGS. 3-5), e.g., based on utilization counter(s) with programmable threshold(s) (e.g., that can be based on link utilization, queue utilization, etc.). Moreover, FIG. 3 shows two critical interconnect resources whose utilization is being monitored (by monitoring logic labeled with “M”). As shown, the stress detection mechanism is located in relatively close proximity to the resource(s) and may be in charge of: (1) monitoring resource utilization and detection of the combined stress on the resource (e.g., and is based on the programmed threshold for this resource utilization level). This information is used for the overall decision of whether the resource is in-stress (oversubscribed) and interconnect admission control need to be applied, or the network resource is operating normally and no admission control need to be applied on the network sources; and (2) monitoring the contribution of each individual network source (module) or the predefined groups of sources to the overall critical resource utilization; thus, being able to detect (based on this information) the level of impact of each individual source or type of source on the resource utilization. This information is used in case that resource is in-stress (its overall utilization is beyond a threshold) to adaptively control the allowed interconnect admission level for the each individual source or type of source. In an embodiment, logic 150 may include the monitoring logic of FIG. 3.

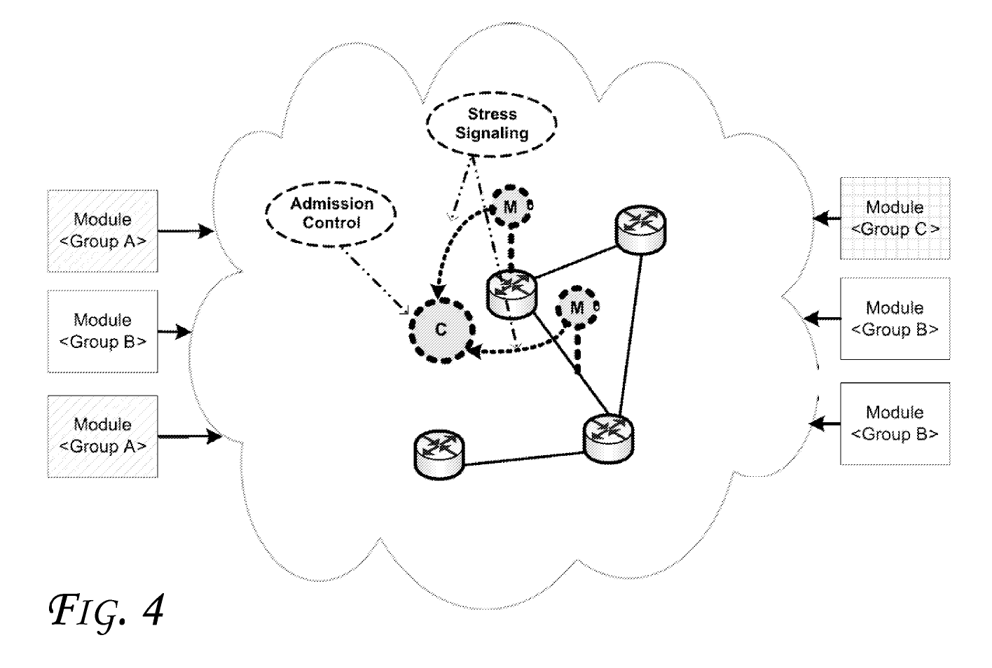

(B) Stress signaling mechanism (see, e.g., FIG. 4, which illustrates a sample network or interconnect that provides stress signaling towards central admission control for decision on the level of adaptive admission control, according to an embodiment): in this implementation overall stress is detected via the monitored critical resource(s) (e.g., monitored by monitoring logic labeled with “M”) and the mechanism signals information about the stress and/or the relative level of contribution of different traffic sources to this stress (via one or more signals) to a central admission control logic. The sources are agents or groups of agents, coupled to the (e.g., on-die) interconnect, whose traffic contributes to the resource stress. In an embodiment, logic 150 includes the monitoring logic and/or the central admission control.

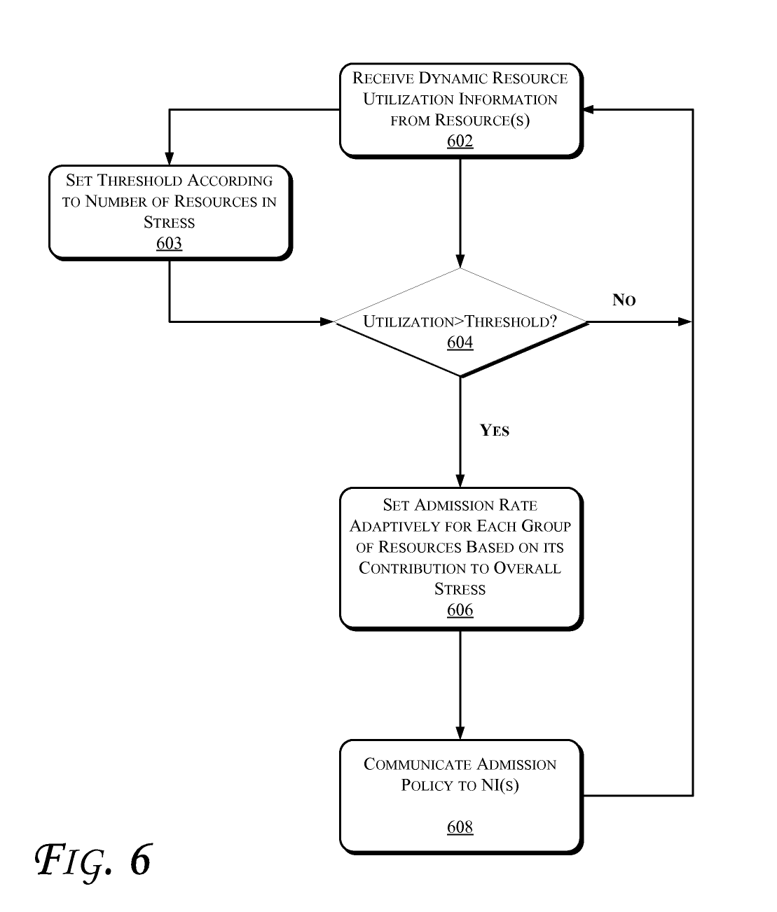

(C) Central adaptive admission control mechanism (see, e.g., FIG. 4): a centralized mechanism (labeled as “c” in FIG. 4) collects stress information about critical resources in the interconnect and the relative contribution of system traffic sources or groups of sources to each stress detected in the system interconnect. Based on this dynamic information, the central admission control mechanism adapts the level of throttling for the different “aggressors” sources traffic, i.e., admission control policy for each source or groups of sources. Therefore, interconnect admission control policy is applied dynamically based on the number of critical resources in stress and/or their level of utilization. The policy is adaptive for each source of predefined group of sources based on its dynamic contribution to the network resource(s) utilization. Admission control policy may be continuously refined (dynamically) based on the streaming information from the resource (s) monitoring mechanisms (such as monitoring logic discussed with reference to FIGS. 3-4). The central admission control (which is provided by logic 150 in an embodiment) is capable of responding differently according to the number of resources in stress. For example, multiple resources in distress may require stricter admission control policy than a case of single resource in stress. Admission control also takes into account various agent's minimal QoS requirements and sets the global admission control policy accordingly. Also this mechanism enables deadlock freedom and system forward progress. Admission control policy is signaled towards admission control policy enforcement mechanism. FIG. 6 illustrates a flow diagram for admission control, according to an embodiment, as will be further discussed below.

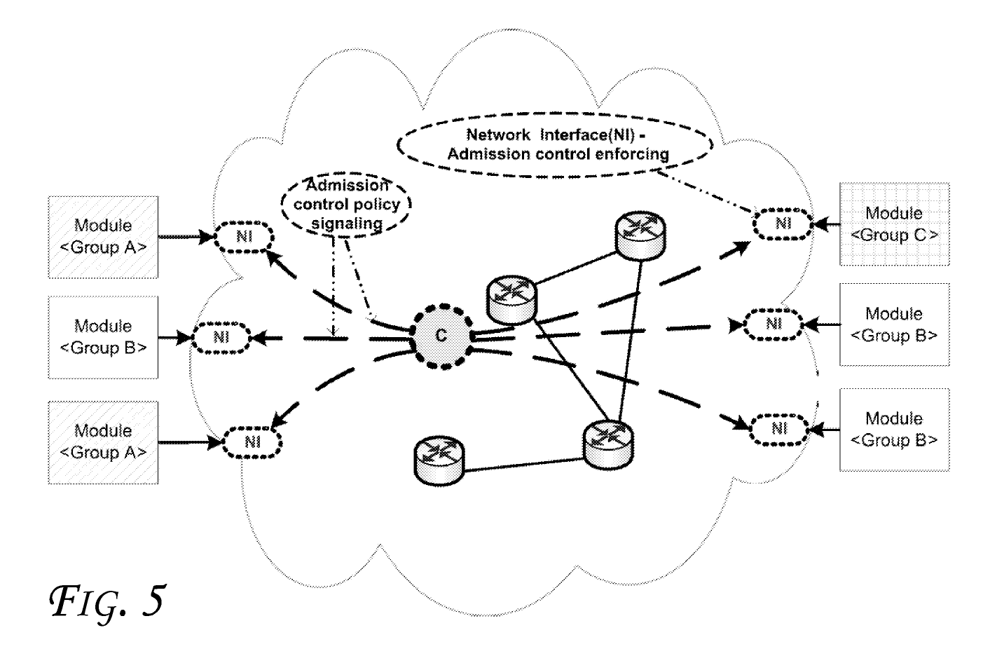

(D) Admission control policy signaling mechanism (see, e.g., FIG. 5 which illustrates a sample interconnect or network with admission control policy signaling from admission control component towards Network Interfaces (NIs) that perform network admission control policy enforcement, according to an embodiment): admission control policy is defined in admission control mechanism and is signaled towards the policy enforcement modules, see FIG. 5. The signaling is carried by dedicated channels either by dedicated physical or switched virtual channels, and thus decoupled from the network load and not affected by it.

(E) Admission control policy enforcement mechanism: admission control policy is enforced in the point of coupling between system module(s) and the interconnect (labeled as NI in FIG. 5). NI receives the appropriate policy (e.g., adaptively according to its group or type) from admission control mechanism in terms of allowed bandwidth for that source, and enforces it by not allowing the source to exceed its allocated allowed bandwidth, see, e.g., FIG. 5.

As discussed above, FIG. 6 illustrates a flow diagram for admission control, according to an embodiment. In one embodiment, logic 150 (or central admission control logic “C”) performs one or more of the operations of FIG. 6. More specifically, at operation 602, dynamic resource utilization information is received from (e.g., all) resources in the system. At an operation 603, the threshold is set based on the number of resources in stress. At an operation 604, it is determined whether the utilization is exceeding the threshold value (i.e., indicating resource in stress). If not, method resumes with operation 602; otherwise, an operation 606 sets admission rate adaptively for each group of resources (or each resource) based on its contribution to overall stress. At an operation 608, the admission policy/values are communicated to the NIs and the method resumes at operation 602.

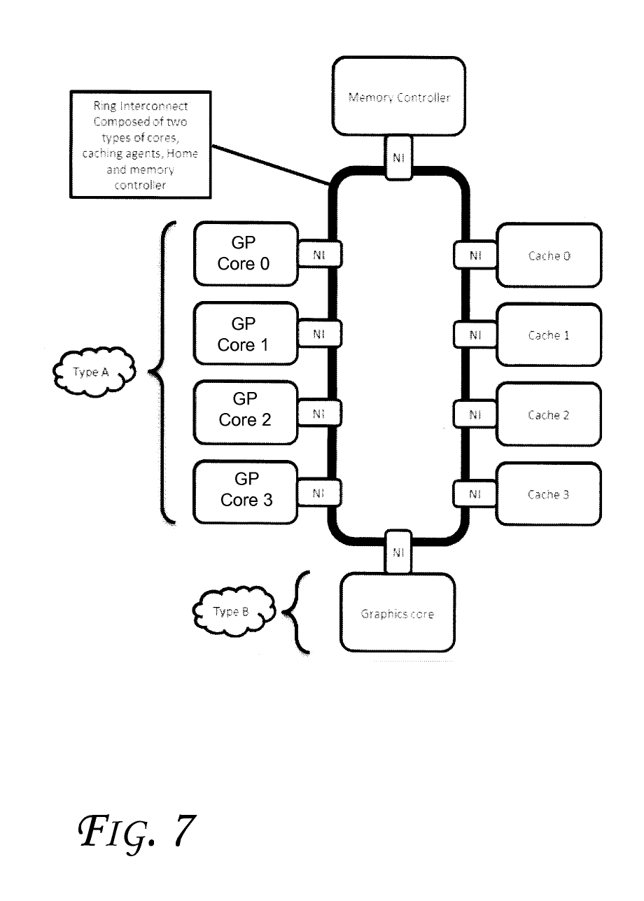

Furthermore, in some embodiments, logic 150 is provided in a processor (or Central Processing Unit (CPU)), e.g., as a solution for a ring interconnect (such as discussed with reference to FIGS. 7-9). Hence, logic 150 controls ring utilization, and reacts adaptively for different types of sources (e.g., general purpose and graphics cores) according to their impact on the overall system. It may also ensure forward progress and can be implemented in its entirety within the interconnect, without any support from the source modules. Such implements are envisioned to improve power/performance characteristics of a processor and/or reduce its cost.

More particularly, FIGS. 7-9 illustrate block diagrams of a sample ring interconnect, a sample ring interconnect with stress detection and signaling for two different types of processor cores, and a sample ring interconnect with central admission control decision capability, respectively, according to some embodiments.

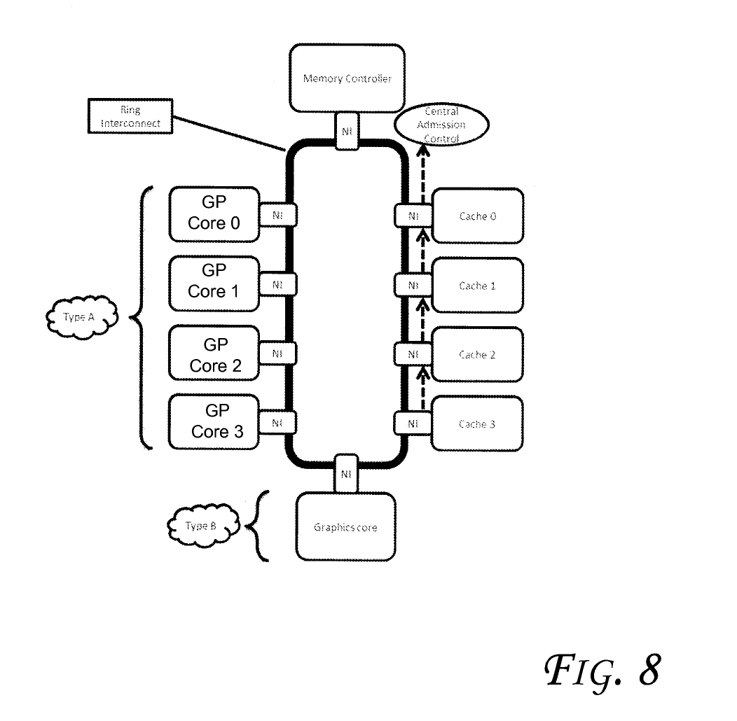

For example, a processor includes an interconnect ring between General Purpose (GP) cores, graphics cores, caching agents (e.g., caches 0-3), and memory controller (such as those discussed with reference to FIGS. 2 and 12-13). In the examples of FIGS. 7-9, caches (e.g., acting as caching agents) and NIs are the critical resources. Each caching agent monitors its utilization level, and generates stress indication signals accordingly (where the indications may include information about the source of the stress—such as GP cores or graphics core). Also, the caching agent NIs send stress information to the central admission control unit (or logic 150). Each caching agent NI receives the stress indication from NI below, appends its own state and passes the information up towards the admission control unit (see, e.g., FIG. 8).

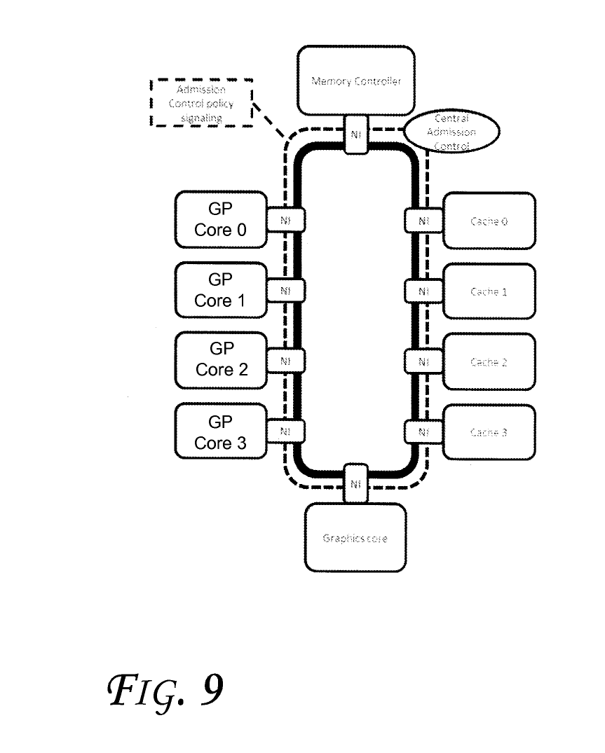

The central admission control unit (or logic 150) receives the stress indication from (e.g., all) caching agents NIs, thus it can determine the best admission control policy to improve overall system performance. Logic 150 determines the admission control level for each type of core according to the number of resources in stress, and/or the current or previous utilization levels. Also, more agents in stress cause the controller to apply stricter admission control (see, e.g., FIG. 9).

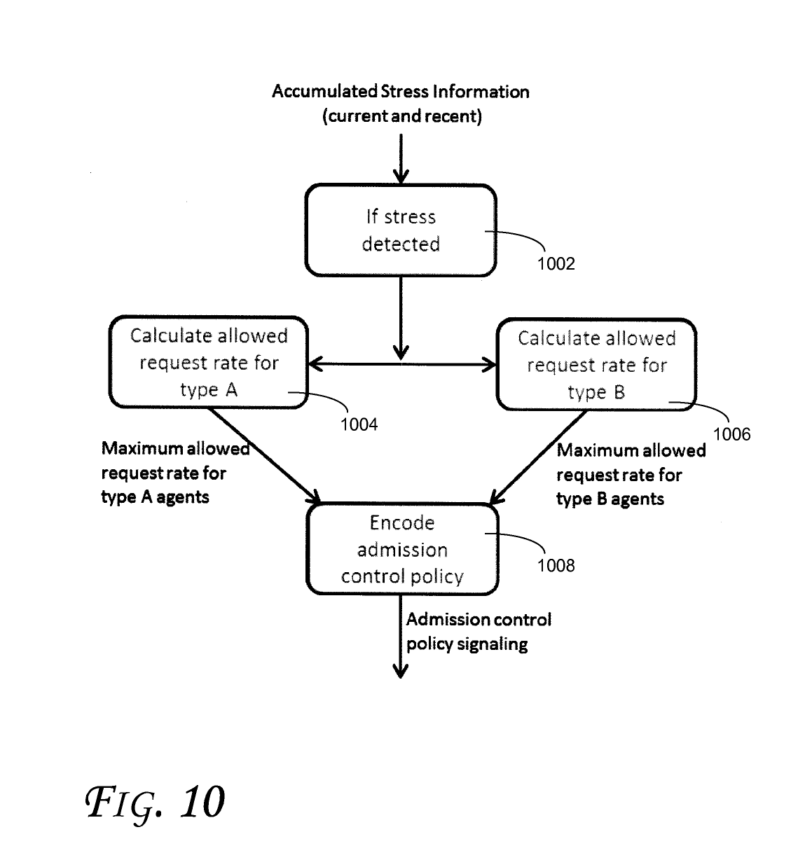

In an embodiment (see, e.g., FIG. 10), the central admission control unit divides ring bandwidth between the different agents dynamically. It encodes its decision into the policy signaling wires that are transmitted over the ring. Thus, each slot on the ring is marked according to the agents that are allowed to consume it.

More particularly, FIG. 10 illustrates a flow diagram for admission control policy signaling and admission control policy enforcement, according to an embodiment. Accumulated stress information (e.g., current and recent) are used to detect stress at operation 1002. the allowed request rate for each type of source is determined at operations 1004/1006. The maximum allowed request rate is then communicated to encode admission control policy at operation 1008 (and the admission control policy is transmitted accordingly).

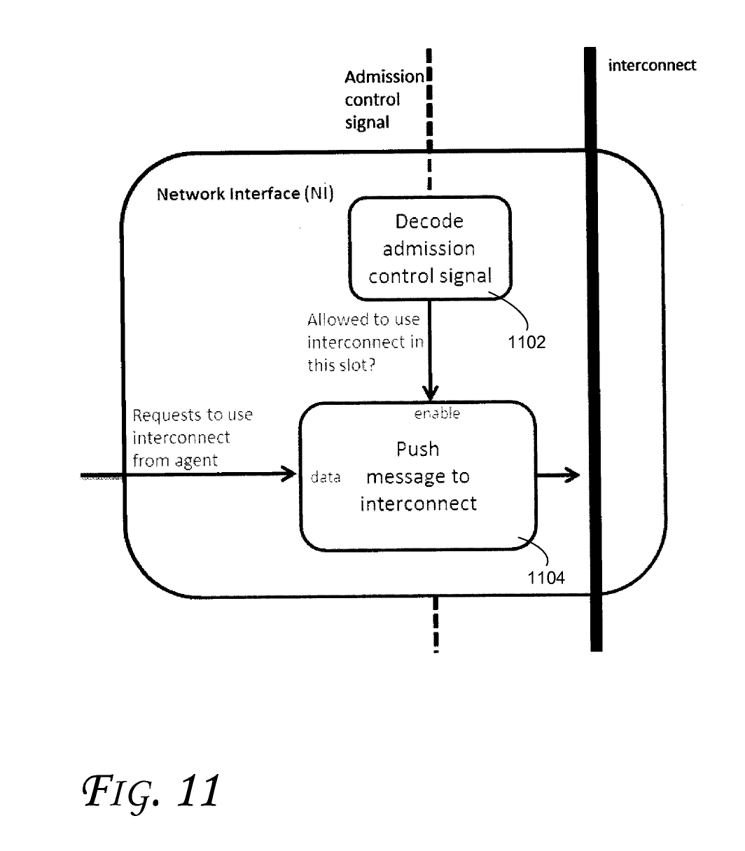

Referring to FIG. 11, the policy signaling wires are part to the interconnect ring (e.g., independent of other traffic). They are set by central admission control mechanism (e.g., logic 150), and read by all NIs. Each NI operates as a function of its encoding. Also, each agent NI continuously monitors the admission control signal, and allows the agent to access the interconnect only when the admission control signal allows it (e.g., as indicated in FIG. 11).

More particularly, FIG. 11 illustrates a block diagram of an NI capable of implementing admission control enforcement, according to an embodiment. As illustrated, NI receives an admission control signal (e.g., from logic 150) and decodes the admission control signal at logic 1102 to determined whether the NI is allowed to use the interconnect in this slot. If allowed (e.g., as indicated by an enable signal provided to logic 1104), the message (or data) is sent to the interconnect by logic 1104 (e.g., in response to request(s) to use the interconnect from an agent).

The table below illustrates some sample data for implementation of admission control policy enforcement and various agent NI action based on admission control encoding, according to some embodiments.

| Admission | | | |
|---|---|---|---|
| Control | Agent NI Action (e.g., allowed to use interconnect) | | |
| Encoding | Cache | GP Core | Graphics Core |
| 00 | can use this slot | can use this slot | can use this slot |
| 01 | can use this slot | can use this slot | slot use is forbidden |
| 10 | can use this slot | slot use is forbidden | can use this slot |
| 11 | can use this slot | slot use is forbidden | slot use is forbidden |

FIG. 12 illustrates a block diagram of an embodiment of a computing system 1200. One or more of the agents 102 of FIG. 1 may comprise one or more components of the computing system 1200. Also, various components of the system 1200 may include logic 150 as illustrated in FIG. 12. However, logic 150 may be provided in locations throughout the system 1200, including or excluding those illustrated. The computing system 1200 may include one or more central processing unit(s) (CPUs) 1202 (which may be collectively referred to herein as “processors 1202” or more generically “processor 1202”) coupled to an interconnection network (or bus) 1204. The processors 1202 may be any type of processor such as a general purpose processor, a network processor (which may process data communicated over a computer network 1205), etc. (including a reduced instruction set computer (RISC) processor or a complex instruction set computer (CISC)). Moreover, the processors 1202 may have a single or multiple core design. The processors 1202 with a multiple core design may integrate different types of processor cores on the same integrated circuit (IC) die. Also, the processors 1202 with a multiple core design may be implemented as symmetrical or asymmetrical multiprocessors.

The processor 1202 may include one or more caches, which may be private and/or shared in various embodiments. Generally, a cache stores data corresponding to original data stored elsewhere or computed earlier. To reduce memory access latency, once data is stored in a cache, future use may be made by accessing a cached copy rather than prefetching or recomputing the original data. The cache(s) may be any type of cache, such a level 1 (L1) cache, a level 2 (L2) cache, a level 3 (L3), a mid-level cache, a last level cache (LLC), etc. to store electronic data (e.g., including instructions) that is utilized by one or more components of the system 1200. Additionally, such cache(s) may be located in various locations (e.g., inside other components to the computing systems discussed herein, including systems of FIG. 1, 2, 12, or 13).

A chipset 1206 may additionally be coupled to the interconnection network 1204. Further, the chipset 1206 may include a graphics memory control hub (GMCH) 1208. The GMCH 1208 may include a memory controller 1210 that is coupled to a memory 1212. The memory 1212 may store data, e.g., including sequences of instructions that are executed by the processor 1202, or any other device in communication with components of the computing system 1200. Also, in one embodiment of the invention, the memory 1212 may include one or more volatile storage (or memory) devices such as random access memory (RAM), dynamic RAM (DRAM), synchronous DRAM (SDRAM), static RAM (SRAM), etc. Nonvolatile memory may also be utilized such as a hard disk. Additional devices may be coupled to the interconnection network 1204, such as multiple processors and/or multiple system memories.

The GMCH 1208 may further include a graphics interface 1214 coupled to a display device 1216 (e.g., via a graphics accelerator in an embodiment). In one embodiment, the graphics interface 1214 may be coupled to the display device 1216 via an accelerated graphics port (AGP). In an embodiment of the invention, the display device 1216 (such as a flat panel display) may be coupled to the graphics interface 1214 through, for example, a signal converter that translates a digital representation of an image stored in a storage device such as video memory or system memory (e.g., memory 1212) into display signals that are interpreted and displayed by the display 1216.

As shown in FIG. 12, a hub interface 1218 may couple the GMCH 1208 to an input/output control hub (ICH) 1220. The ICH 1220 may provide an interface to input/output (I/O) devices coupled to the computing system 1200. The ICH 1220 may be coupled to a bus 1222 through a peripheral bridge (or controller) 1224, such as a peripheral component interconnect (PCI) bridge that may be compliant with the PCIe specification, a universal serial bus (USB) controller, etc. The bridge 1224 may provide a data path between the processor 1202 and peripheral devices. Other types of topologies may be utilized. Also, multiple buses may be coupled to the ICH 1220, e.g., through multiple bridges or controllers. Further, the bus 1222 may comprise other types and configurations of bus systems. Moreover, other peripherals coupled to the ICH 1220 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), etc.

The bus 1222 may be coupled to an audio device 1226, one or more disk drive(s) 1228, and a network adapter 1230 (which may be a NIC in an embodiment). In one embodiment, the network adapter 1230 or other devices coupled to the bus 1222 may communicate with the chipset 1206. Also, various components (such as the network adapter 1230) may be coupled to the GMCH 1208 in some embodiments of the invention. In addition, the processor 1202 and the GMCH 1208 may be combined to form a single chip. In an embodiment, the memory controller 1210 may be provided in one or more of the CPUs 1202. Further, in an embodiment, GMCH 1208 and ICH 1220 may be combined into a Peripheral Control Hub (PCH).

Additionally, the computing system 1200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 1228), a floppy disk, a compact disk ROM (CD-ROM), a digital versatile disk (DVD), flash memory, a magneto-optical disk, or other types of nonvolatile machine-readable media capable of storing electronic data (e.g., including instructions).

The memory 1212 may include one or more of the following in an embodiment: an operating system (O/S) 1232, application 1234, directory 1201, and/or device driver 1236. The memory 1212 may also include regions dedicated to Memory Mapped I/O (MMIO) operations. Programs and/or data stored in the memory 1212 may be swapped into the disk drive 1228 as part of memory management operations. The application(s) 1234 may execute (e.g., on the processor(s) 1202) to communicate one or more packets with one or more computing devices coupled to the network 1205. In an embodiment, a packet may be a sequence of one or more symbols and/or values that may be encoded by one or more electrical signals transmitted from at least one sender to at least on receiver (e.g., over a network such as the network 1205). For example, each packet may have a header that includes various information which may be utilized in routing and/or processing the packet, such as a source address, a destination address, packet type, etc. Each packet may also have a payload that includes the raw data (or content) the packet is transferring between various computing devices over a computer network (such as the network 1205).

In an embodiment, the application 1234 may utilize the O/S 1232 to communicate with various components of the system 1200, e.g., through the device driver 1236. Hence, the device driver 1236 may include network adapter 1230 specific commands to provide a communication interface between the O/S 1232 and the network adapter 1230, or other I/O devices coupled to the system 1200, e.g., via the chipset 1206.

In an embodiment, the O/S 1232 may include a network protocol stack. A protocol stack generally refers to a set of procedures or programs that may be executed to process packets sent over a network 1205, where the packets may conform to a specified protocol. For example, TCP/IP (Transport Control Protocol/Internet Protocol) packets may be processed using a TCP/IP stack. The device driver 1236 may indicate the buffers in the memory 1212 that are to be processed, e.g., via the protocol stack.

The network 1205 may include any type of computer network. The network adapter 1230 may further include a direct memory access (DMA) engine, which writes packets to buffers (e.g., stored in the memory 1212) assigned to available descriptors (e.g., stored in the memory 1212) to transmit and/or receive data over the network 1205. Additionally, the network adapter 1230 may include a network adapter controller, which may include logic (such as one or more programmable processors) to perform adapter related operations. In an embodiment, the adapter controller may be a MAC (media access control) component. The network adapter 1230 may further include a memory, such as any type of volatile/nonvolatile memory (e.g., including one or more cache(s) and/or other memory types discussed with reference to memory 1212).

FIG. 13 illustrates a computing system 1300 that is arranged in a point-to-point (PtP) configuration, according to an embodiment of the invention. In particular, FIG. 13 shows a system where processors, memory, and input/output devices are interconnected by a number of point-to-point interfaces. The operations discussed with reference to FIGS. 1-12 may be performed by one or more components of the system 1300.

As illustrated in FIG. 13, the system 1300 may include several processors, of which only two, processors 1302 and 1304 are shown for clarity. The processors 1302 and 1304 may each include a local memory controller hub (GMCH) 1306 and 1308 to enable communication with memories 1310 and 1312. The memories 1310 and/or 1312 may store various data such as those discussed with reference to the memory 1312 of FIG. 13. As shown in FIG. 13, the processors 1302 and 1304 (or other components of system 1300 such as chipset 1320, I/O devices 1343, etc.) may also include one or more cache(s) such as those discussed with reference to FIGS. 1-12.

In an embodiment, the processors 1302 and 1304 may be one of the processors 1302 discussed with reference to FIG. 13. The processors 1302 and 1304 may exchange data via a point-to-point (PtP) interface 1314 using PtP interface circuits 1316 and 1318, respectively. Also, the processors 1302 and 1304 may each exchange data with a chipset 1320 via individual PtP interfaces 1322 and 1324 using point-to-point interface circuits 1326, 1328, 1330, and 1332. The chipset 1320 may further exchange data with a high-performance graphics circuit 1334 via a high-performance graphics interface 1336, e.g., using a PtP interface circuit 1337.

In at least one embodiment, a directory cache and/or logic may be provided in one or more of the processors 1302, 1304 and/or chipset 1320. Other embodiments of the invention, however, may exist in other circuits, logic units, or devices within the system 1300 of FIG. 13. Furthermore, other embodiments of the invention may be distributed throughout several circuits, logic units, or devices illustrated in FIG. 13. For example, various components of the system 1300 may include the logic 150 of FIG. 1. However, logic 150 may be provided in locations throughout the system 1300, including or excluding those illustrated.

The chipset 1320 may communicate with the bus 1340 using a PtP interface circuit 1341. The bus 1340 may have one or more devices that communicate with it, such as a bus bridge 1342 and I/O devices 1343. Via a bus 1344, the bus bridge 1342 may communicate with other devices such as a keyboard/mouse 1345, communication devices 1346 (such as modems, network interface devices, or other communication devices that may communicate with the computer network 1305), audio I/O device, and/or a data storage device 1348. The data storage device 1348 may store code 1349 that may be executed by the processors 1302 and/or 1304.

The following examples pertain to further embodiments. Example 1 includes an apparatus comprising: logic to determine whether to cause a change in an admission rate of requests from one or more sources of data based at least in part on comparison of a threshold value and resource utilization information, wherein the resource utilization information is to be received from a plurality of resources that are shared amongst the one or more sources of data, wherein the one or more sources of data are coupled to communicate via an interconnect, and wherein the threshold value is to be determined based at least in part on a number of the plurality of resources that are determined to be in a congested condition. Example 2 includes the apparatus of example 1, wherein each of the one or more sources of data is to communicate with the interconnect via a network interface and wherein the logic is to cause a change in the admission rate of requests from the one or more sources of data via a corresponding network interface. Example 3 includes the apparatus of example 1, wherein the one or more sources of data are to comprise one or more of: a general purpose processor core and a graphics processor core. Example 4 includes the apparatus of example 1, wherein the plurality of resources are to comprise one or more of: one or more caches and a memory controller. Example 5 includes the apparatus of example 4, wherein the one or more caches are to communicate their utilization value to the logic in series. Example 6 includes the apparatus of example 1, comprising logic to monitor the plurality of resources to determine the resource utilization information. Example 7 includes the apparatus of example 1, wherein the logic is to cause the change in the admission rate of requests from the one or more sources of data based at least in part on admission control policy transmission. Example 8 includes the apparatus of example 1, wherein the logic is to couple a first agent to a second agent. Example 9 includes the apparatus of example 8, wherein one or more of the first agent and the second agent are to comprise a plurality of processor cores. Example 10 includes the apparatus of example 8, wherein one or more of the first agent and the second agent are to comprise a plurality of sockets. Example 11 includes the apparatus of example 1, wherein the interconnect is to comprise a ring interconnect. Example 12 includes the apparatus of example 1, wherein the interconnect is to comprise a point-to-point interconnect. Example 13 includes the apparatus of example 1, wherein one or more of: the logic, one or more general purpose processor cores, one or more graphics processor cores, a memory controller, and memory are on a same integrated circuit die.

Example 14 includes a method comprising: determining whether to cause a change in an admission rate of requests from one or more sources of data based at least in part on comparison of a threshold value and resource utilization information, wherein the resource utilization information is received from a plurality of resources that are shared amongst the one or more sources of data, wherein the one or more sources of data communicate via an interconnect, and wherein the threshold value is determined based at least in part on a number of the plurality of resources that are determined to be in a congested condition. Example 15 includes the method of example 14, further comprising each of the one or more sources of data communicating with the interconnect via a network interface and causing a change in the admission rate of requests from the one or more sources of data via a corresponding network interface. Example 16 includes the method of example 14, further comprising the one or more caches communicating their utilization value in series. Example 17 includes the method of example 14, further comprising monitoring the plurality of resources to determine the resource utilization information. Example 18 includes the method of example 14, further comprising causing the change in the admission rate of requests from the one or more sources of data based at least in part on admission control policy transmission. Example 19 includes the method of example 14, wherein the interconnect is to comprise a ring interconnect. Example 20 includes the method of example 14, wherein the interconnect is to comprise a point-to-point interconnect.

Example 21 includes a system comprising: memory to store resource utilization information; and logic to determine whether to cause a change in an admission rate of requests from one or more sources of data based at least in part on comparison of a threshold value and the resource utilization information, wherein the resource utilization information is to be received from a plurality of resources that are shared amongst the one or more sources of data, wherein the one or more sources of data are coupled to communicate via an interconnect, and wherein the threshold value is to be determined based at least in part on a number of the plurality of resources that are determined to be in a congested condition. Example 22 includes the system of example 21, wherein each of the one or more sources of data is to communicate with the interconnect via a network interface and wherein the logic is to cause a change in the admission rate of requests from the one or more sources of data via a corresponding network interface. Example 23 includes the system of example 21, wherein the one or more sources of data are to comprise one or more of: a general purpose processor core and a graphics processor core. Example 24 includes the system of example 21, wherein the plurality of resources are to comprise one or more of: one or more caches and a memory controller. Example 25 includes the system of example 21, comprising logic to monitor the plurality of resources to determine the resource utilization information.

Example 26 includes a computer-readable medium comprising one or more instructions that when executed on a processor configure the processor to perform one or more operations of any of examples 14 to 20.

Example 27 includes an apparatus comprising means to perform a method as set forth in any of examples 14 to 20.

Example 28 includes the apparatus of any of examples 1 to 13 or examples 21-25, wherein each of the one or more sources of data communicates with the interconnect via a network interface and wherein the logic is to cause a change in the admission rate of requests from the one or more sources of data via a corresponding network interface.

Example 29 includes the apparatus of any of examples 1 to 13, wherein one or more caches are to communicate their utilization value in series.

Example 30 includes the method of any of examples 14 to 20, wherein one or more caches are to communicate their utilization value in series.

In various embodiments of the invention, the operations discussed herein, e.g., with reference to FIGS. 1-13, may be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-13. Additionally, such computer-readable media may be downloaded as a computer program product, wherein the program may be transferred from a remote computer (e.g., a server) to a requesting computer (e.g., a client) through data signals in a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic to determine whether to cause a change in an admission rate of requests from one or more sources of data based at least in part on comparison of a threshold value and resource utilization information,
wherein the resource utilization information is to be received from a plurality of resources that are shared amongst the one or more sources of data, wherein the one or more sources of data are coupled to communicate via an interconnect, and wherein the threshold value is to be determined based at least in part on a number of the plurality of resources that are determined to be in a congested condition.

2. The apparatus of claim 1, wherein each of the one or more sources of data is to communicate with the interconnect via a network interface and wherein the logic is to cause a change in the admission rate of requests from the one or more sources of data via a corresponding network interface.

3. The apparatus of claim 1, wherein the one or more sources of data are to comprise one or more of: a general purpose processor core and a graphics processor core.

4. The apparatus of claim 1, wherein the plurality of resources are to comprise one or more of: one or more caches and a memory controller.

5. The apparatus of claim 4, wherein the one or more caches are to communicate their utilization value to the logic in series.

6. The apparatus of claim 1, comprising logic to monitor the plurality of resources to determine the resource utilization information.

7. The apparatus of claim 1, wherein the logic is to cause the change in the admission rate of requests from the one or more sources of data based at least in part on admission control policy transmission.

8. The apparatus of claim 1, wherein the logic is to couple a first agent to a second agent.

9. The apparatus of claim 8, wherein one or more of the first agent and the second agent are to comprise a plurality of processor cores.

10. The apparatus of claim 8, wherein one or more of the first agent and the second agent are to comprise a plurality of sockets.

11. The apparatus of claim 1, wherein the interconnect is to comprise a ring interconnect.

12. The apparatus of claim 1, wherein the interconnect is to comprise a point-to-point interconnect.

13. The apparatus of claim 1, wherein one or more of: the logic, one or more general purpose processor cores, one or more graphics processor cores, a memory controller, and memory are on a same integrated circuit die.

14. A method comprising:
determining whether to cause a change in an admission rate of requests from one or more sources of data based at least in part on comparison of a threshold value and resource utilization information,
wherein the resource utilization information is received from a plurality of resources that are shared amongst the one or more sources of data, wherein the one or more sources of data communicate via an interconnect, and wherein the threshold value is determined based at least in part on a number of the plurality of resources that are determined to be in a congested condition.

15. The method of claim 14, further comprising each of the one or more sources of data communicating with the interconnect via a network interface and causing a change in the admission rate of requests from the one or more sources of data via a corresponding network interface.

16. The method of claim 14, further comprising the one or more caches communicating their utilization value in series.

17. The method of claim 14, further comprising monitoring the plurality of resources to determine the resource utilization information.

18. The method of claim 14, further comprising causing the change in the admission rate of requests from the one or more sources of data based at least in part on admission control policy transmission.

19. The method of claim 14, wherein the interconnect is to comprise a ring interconnect.

20. The method of claim 14, wherein the interconnect is to comprise a point-to-point interconnect.

21. A system comprising:
memory to store resource utilization information; and
logic to determine whether to cause a change in an admission rate of requests from one or more sources of data based at least in part on comparison of a threshold value and the resource utilization information,
wherein the resource utilization information is to be received from a plurality of resources that are shared amongst the one or more sources of data, wherein the one or more sources of data are coupled to communicate via an interconnect, and wherein the threshold value is to be determined based at least in part on a number of the plurality of resources that are determined to be in a congested condition.

22. The system of claim 21, wherein each of the one or more sources of data is to communicate with the interconnect via a network interface and wherein the logic is to cause a change in the admission rate of requests from the one or more sources of data via a corresponding network interface.

23. The system of claim 21, wherein the one or more sources of data are to comprise one or more of: a general purpose processor core and a graphics processor core.

24. The system of claim 21, wherein the plurality of resources are to comprise one or more of: one or more caches and a memory controller.

25. The system of claim 21, comprising logic to monitor the plurality of resources to determine the resource utilization information.
